(19) United States
(12) Patent Application Publication
(10) Pub. No.: US 2018/0375808 A1
(43) Pub. Date: Dec. 27, 2018

(54) A COMMUNICATION SYSTEM AND A COMMUNICATION PROCESS FOR ENABLING A FIRST AND SECOND USER TO COMMUNICATE OVER A COMMUNICATION SYSTEM

(71) Applicant: UniTalk LTD, Cardiff (GB)

(72) Inventor: Martin Graham HARRIS, Cardiff (GB)

(73) Assignee: UniTalk LTD, Cardiff (GB)

(21) Appl. No.: 16/062,375

(22) PCT Filed: Dec. 16, 2016
(86) PCT No.: PCT/GB2016/053965

§ 371 Date: Jun. 14, 2018

(30) Foreign Application Priority Data
Dec. 16, 2015 (GB) 1522187.2

(51) Int. Cl. H04L 12/58

(52) U.S. Cl. CPC H04L 51/063; G06F 17/289; H04L 51/02; H04L 51/32

(57) ABSTRACT

A communications system (10) comprises a hand held access terminal (11) which enables a first user and a second user to communicate using a plurality of predetermined questions and answers, which are stored in a repository (12) and are selectable by the first and second users via said access terminal. The questions and answers are stored in a plurality of different languages, so that users of different languages can communicate with each other.

The present invention relates to a communications system and a communication process for enabling a first and second user to communicate over a communications system.

Young children and people with learning difficulties often find it difficult to communicate with other people over a communications network. This may be because of a disability which affect the persons' ability to manipulate a keyboard for example, or because of a disability to socially interact and hold a conversation with another person. Alternatively, a person may simply lack the required knowledge or experience in computer technology. Similar problems exist when communicating with a person who has little or no working knowledge of the language of the person with whom they are communicating.

When children and young people communicate over a social networking site it is also a concern that one of the parties to the conversation may abuse the networking site, for example by divulging material which is not suitable for the other party to the conversation.

Our UK Patent GB24797B discloses a communications network comprising a first user access terminal and a second user access terminal which enable a first user and a second user respectively to communicate over the network, the network further comprising a repository which is accessible via the first user access terminal and the second user access terminal, and which comprises a plurality of predetermined questions and answers, which are selectable by the first user via the first user access terminal and by the second user via the second user access terminal, such that the communication network enables the first user to select a question from the plurality of predetermined questions for the second user to answer, and enables the second user to answer the question by selecting one of the plurality of present answers, wherein

the communications network further enables the second user to select a question from the plurality of predetermined questions for the first user to answer after responding to the preceding question of the first user.

The network thus encourages both parties to the conversation to communicate and submit enquires and questions, since a second user can only ask a question after having responded to a previous question from a first user. Accordingly, the network enables persons who may otherwise lack social interaction skills to develop their confidence by asking and answering questions.

There is often the need for parties to communicate face-to-face in different languages, for example in schools where the parent of a child may not be familiar with the language used by the school.

We have now devised a communications system and a process for enabling a first and second user to communicate using the system, which alleviates the above-mentioned problems.

In accordance with the present invention as seen from a first aspect, there is provided a communications system comprising an access terminal which enable a first user and a second user to communicate,

the system further comprising a repository which is accessible via said access terminal and which comprises a plurality of predetermined questions and answers, which are selectable by the first user via said access terminal and by the second user via said access terminal, such that the system enables the first user to select a question from the plurality of predetermined questions for the second user to answer, and enables the second user to answer the question by selecting one of the plurality of present answers.

In this manner, the users are able to communicate face-to-face using the same access terminal, which may be portable and which comprise a tablet computer or smart phone that can be handed back and forwards between the users during the course of their communication.

The system may further enable the second user to select a question from the plurality of predetermined questions for the first user to answer after responding to the preceding question of the first user.

Preferably, the repository comprises a plurality of predetermined questions and answers in at least two languages, the system preferably enabling at least one of the users to select their language of choice prior to communicating. The system may have a default language, which one of the users will always use and so it is not necessary for both users to select their language. Preferably, the system enables the first user to select and answer questions in a first language and enables the second user answer and select questions in a second language, so that the users can communicate in different languages.

The repository further comprises processing means which enables the question selected by the first user to be presented to the first user in the first language and to the second user in the second language.

The access terminal comprises a display which is arranged to display the questions and answers, and which is preferably further arranged to display a record of the questions and answers between the first user and the second user.

Preferably, the access terminal further comprises a user interface device, such as touch screen or keypad, to enable the first user and the second user to select questions and answers from the plurality of predetermined questions and answers.

The repository of questions and answers may be stored in the access terminal or may be stored in a remote storage device, which is accessible by the terminal over a communications network such as the internet.

Preferably the system is arranged to audibly present the questions and/or answers to a user in their selected language, in case the user cannot read or has impaired vision.

In accordance with the present invention as seen from the first aspect, there is provided a method of communicating using a communications system in accordance with the present invention as seen from the first aspect.

Also, in accordance with the present invention as seen from a first aspect, there is provided a communication process for enabling a first and second user to communicate using a communications system, the process comprising:
enabling the first user to select a predetermined question from a plurality of predetermined questions for sending to the second user;
displaying the predetermined question from the first user to the second user;
enabling the second user to select a present answer to the question, from a plurality of present answers, for displaying to the first user in response to the question.

Since all of the communication is completely predetermined and vetted prior to becoming available on the repository, then the process prevents members from being subjected to online bullying, abuse, harassment or fraud.

The process may further enable the second user to select a predetermined question from a plurality of predetermined questions for displaying to the first user after having responded to the preceding question from the first user. Thus, since a second user can only ask a question after responding to a previous question from a first user, then this prevents the conversation from becoming one-sided and thus encourages both parties to the conversation to communicate and submit enquires and questions, and thus interact.

The groups of questions and answers are preferably categorised into separate languages, such that each group of questions and answers comprises the same questions and answers in a plurality of languages. Preferably at least one of the users is able to select a language prior to communicating.

The user access terminal is preferably arranged to display the questions and answers in a first language selected by the first user and the user access terminal is arranged to display the questions and answers in a second language to the second user. The user access terminal is preferably further arranged to display a record of questions and answers which are communicated between the first user and the second user. In situations where the first user and the second user communicate in different languages, the access terminal is preferably arranged to display the questions and answers in the language selected by the first user and the second user respectively, so that both users are able to understand the prior communication.

Preferably the system is arranged to audibly present the questions and/or answers to a user in their selected language, in case the user cannot read or has impaired vision.

In accordance with the present invention as seen from a second aspect, there is provided a communication system comprising an access terminal which enables a user to interface with a plurality of textual items stored in a repository which is accessible via said access terminal, each textual item being stored in at least two languages, the system enabling the user to select a language of choice prior to communicating such that the textual items are presented to the user from the repository in the selected language.

The communication system of the second aspect enables a user to interact with textual items such as a feedback form or liability waiver in their language of choice.

Preferably the textual items comprise a plurality of predetermined questions and answers, the questions being presented to the user from the repository in the selected language, the access terminal preferably also being configured to present the user with a plurality of answers in the selected language which are selectable by the user in response to the questions.

The system may have a default language, which is different from the selected language. The system may store the user's answers in the default language. The system may also store a record on the language selected by the user. The default language is preferably selectable by an administrator of the system.

Preferably the system is arranged to audibly present the textual messages to the user in their selected language, in case the user cannot read or has impaired vision.

In accordance with the present invention as seen from the second aspect, there is provided a method of interaction using a communications system in accordance with the present invention as seen from the second aspect.

It is well established in schools to send SMS messages to parents or guardians, perhaps informing them that their child is absent or requesting that their child is collected from school. SMS messages are also sent by other establishments to their customers, clients and patients etc.

A disadvantage of this arrangement is that the recipient of the SMS message may not be familiar with the language in which the message is sent.

In accordance with the present invention as seen from a third aspect, there is provided a communication system for communicating with a plurality of recipients, the system comprising an access terminal which stores the contact details of each recipient together with a selected language in which that recipient wishes to communicate, the system further comprising a repository which is accessible by a user via said access terminal and which comprises a plurality of predetermined messages in a first language together with translations of each message into a plurality of different languages, said messages being selectable by the user in said first language for sending to a selected recipient, the system being arranged to transmit the selected message to the selected user in the selected language in which that recipient wishes to communicate.

In this way messages can be sent to recipients in a language which they understand and without the user having to perform any translation.

The system may be arranged to transmit email, voice or SMS messages.

In accordance with the present invention as seen from the third aspect, there is provided a method of communicating using a communications system in accordance with the present invention as seen from the third aspect.

Embodiments of the present invention will now be described by way of examples only and with reference to the accompanying drawings, in which:

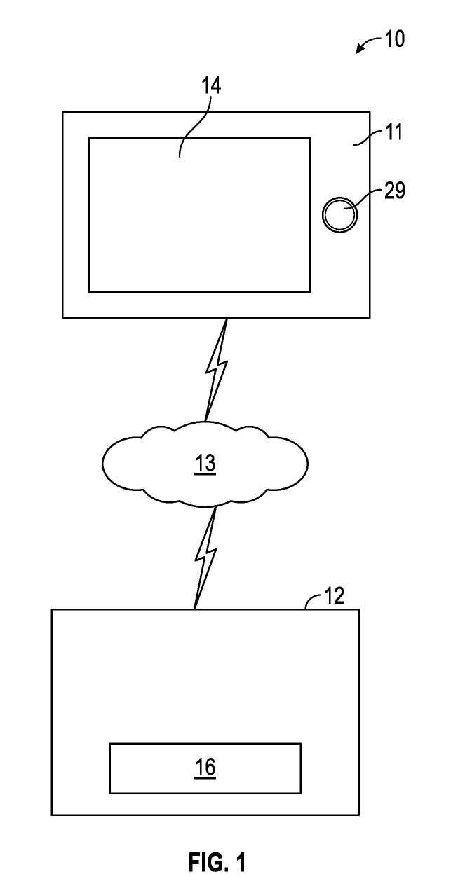

FIG. 1 is schematic illustration of a communications system according to an embodiment of the present invention as seen from the first aspect;

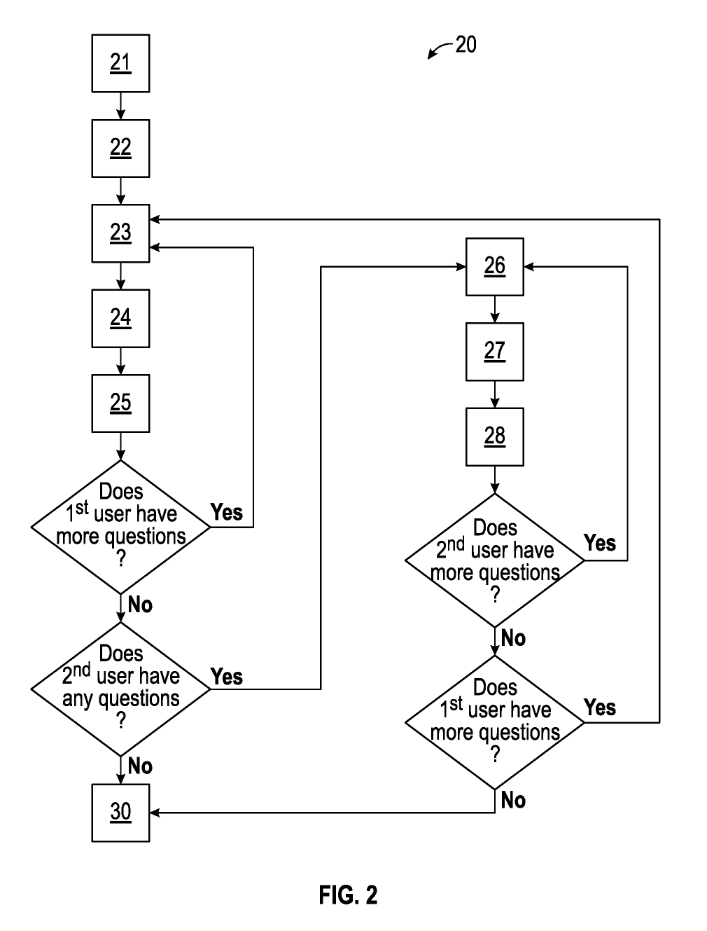

FIG. 2 is a flow chart illustrating a communications process using the system of FIG. 1;

FIG. 3 is schematic illustration of a communications system according to an embodiment of the present invention as seen from the second aspect;

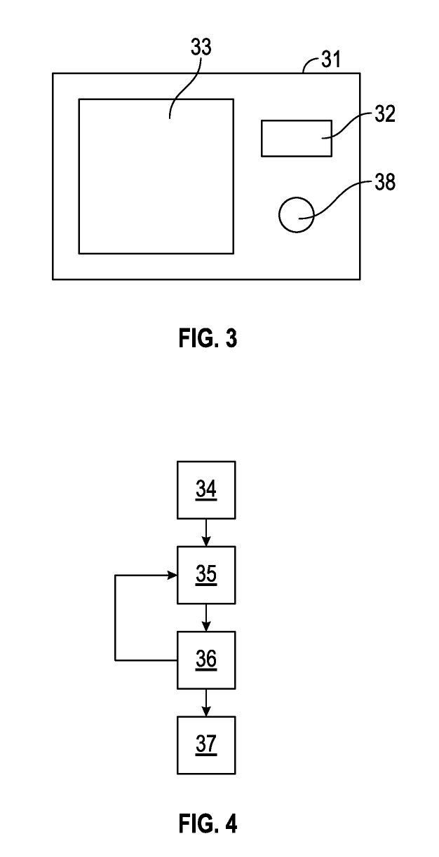

FIG. 4 is a flow chart illustrating a communications process using the system of FIG. 3;

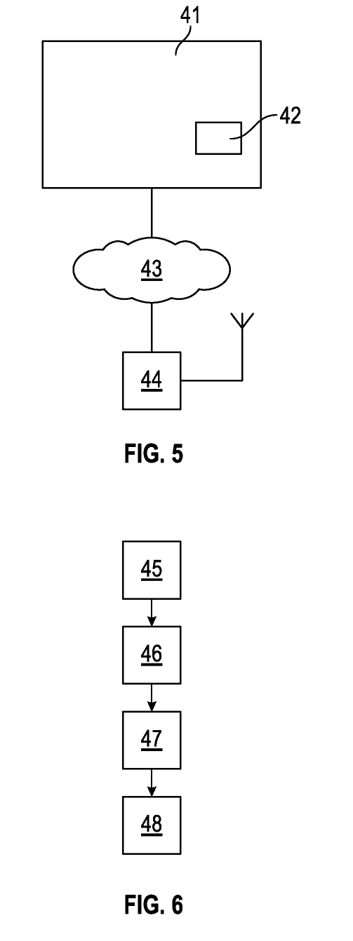

FIG. 5 is schematic illustration of a communications system according to an embodiment of the present invention as seen from the third aspect; and

FIG. 6 is a flow chart illustrating a communications process using the system of FIG. 5.

Referring to FIG. 1 of the drawings, there is illustrated a communications system 10 comprising a user access terminal 11 in the form of a tablet computer, which is arranged to access a repository 12 of conversation questions and answers via the World Wide Web 13 for example, which have been categorised into various conversation topics. Alternatively, the repository 12 may be stored in a memory device disposed inside the terminal or connected thereto.

The repository 12 is amendable such that further conversation topics, languages, questions and answers can be added to the repository 12 and existing conversation topics, questions and answers may be modified or removed. The access terminal 11 comprises a display 14, which is arranged to display a conversation of questions and answers, and a user input device in the form of a touch screen overlying the display 14.

The conversation topics may include categories relating to sport, current affairs, films, hobbies and the like. Each category is further categorised into a plurality of languages such that each conversation topic comprises the conversation questions and answers in a plurality of languages.

Referring to FIG. 2 of the drawings, there is illustrated a communication process 20 for enabling a first and second user to communicate over the communications system 10. A first user may be a nominated user who is able to establish a default language at step 21. In order for the first user to access the various conversation topics and establish communication with a second user, the desired language of the second user (for all the questions and answers which are to be displayed to the second user on the display 14 of the access terminal 11) must firstly be selected at step 22.

The first user may decide to communicate in a preferred language which may be different to the default or selected languages, so that he or she can practice and develop proficiency in the preferred language. The first user then selects a question in his or her preferred language at step 23 which is to be communicated to the second user, who may be standing or sitting close to the first user. Once the question has been selected, the first user may hand the access terminal 11 to the second user.

The repository 12 further comprises a processor 16 which is arranged to cause the selected question to be displayed at step 24 to the second user in the selected language that was selected at step 21. In addition, the processor 16 is further arranged to display at step 25 to the second user a list of predetermined answers to the question from the first user, in the selected language of the second user.

If the preferred language of the first and second users is different, then the processor 16 is arranged to display the second user's answer to the first user in the preferred language of the first user. The first user may wish to ask another question to the second user, at which point steps 23 to 25 are repeated as many times as necessary.

Once the first user has finished asking questions, the second user is able to ask one or more questions. However, if the second user has no questions, the conversation ends at step 30, whereupon the system may record the sequence of questions and answers in the default language. If the second user has questions to ask, the second user then selects a question in his or her selected language at step 26 which is to be communicated to the first user. Once the question has been selected, the second user may hand the access terminal 11 back to the first user.

The processor 16 is arranged to cause the selected question to be displayed at step 27 to the first user in his or her preferred language. In addition, the processor 16 is further arranged to display at step 28 to the first user a list of predetermined answers to the question from the second user, in the preferred language of the first user.

If the preferred language of the first and second users is different, then the processor 16 is arranged to display the first user's answer to the second user in the selected language of the first user. The second user may wish to ask another question to the first user, at which point steps 26 to 28 are repeated as many times as necessary.

Once the second user has finished asking questions, the first user is able to ask one or more questions, at which point steps 23 to 25 are repeated as many times as necessary. However, if the first user has no questions, the conversation ends at step 30, whereupon the system may record the sequence of questions and answers in the default language.

Since each user is only permitted to ask questions from a predetermined list of questions, then this minimises the potential for any misuse of the system. In addition, since the system comprises a repository of a plurality of predetermined questions and answers, which have been vetted by the hosting party and which have been translated into various languages, then there is no requirement for a real time translation tool which may otherwise introduce errors into the dialogue between users, nor for a user to manually type in the required questions and answers.

The network 10 is arranged to only allow the second user to subsequently ask a question to the first user, after the second user has answered the preceding question of the first user. The sequence of conversation questions and answers communicated between the first and second users is displayed on the display 14, so that each user can see a record of what has been asked and answered. The sequence of questions and answers communicated between the first and second users is displayed in the preferred language of the first user and the selected language of the second user, so that the first and second user can develop their understanding of the language of the second and first user, respectively.

The access terminal 10 may comprise a loudspeaker 29 arranged to audibly present the questions and answers messages to the second user in their selected language, in case the user cannot read or has impaired vision. The audio signal applied to the loudspeaker 29 may be stored in the repository 12 or it may be derived by the terminal 11 using a text to speech program.

The communication system and process thus provides for an efficient and safe communication between users in different languages.

Referring to FIG. 3 of the drawings, there is illustrated a communications system comprising a user access terminal 31 in the form of a computer, which is arranged to access a repository 32 of textual items stored in a memory device disposed inside the computer or connected thereto.

The repository 32 is amendable such that further textual items such as statements, questions and answers can be added to the repository 32, and existing textual items may be modified or removed. Each textual item is stored in the repository 32 in a default language and a plurality of other languages. The access terminal 31 comprises a display 33, which is arranged to display the textual items, and a user input device in the form of a touch screen overlying the display 33.

Referring to FIG. 4 of the drawings, there is illustrated a process 34 for enabling a user to interact with the communications system of FIG. 3. The system may, for example, be located in police custody suite for questioning foreign language detainees and for providing them with their statutory rights.

In order for the user to access system, the desired language of the user (for all the statements, questions and answers which are to be displayed to the user on the display 33 of the access terminal 31) must firstly be selected at step 34.

The user is presented at step 35 with the first textual item from a pre-determined sequence stored in the repository 32, the item being presented in the user's selected language. At step 36, if the item is a question, the user may be asked to enter information (such as the user's name and address) or they may be asked to select an answer from a predetermined plurality of answers which are stored in the repository and which are presented to the user in the user's selected language. At step 36, if the item is a statement, the user may be asked to confirm that the statement has been understood or agreed. Steps 35 and 36 are repeated as many times as necessary until the pre-determined sequence of textual items stored in the repository 32 ends, at which point the system may record the user's input in the default language.

The access terminal 31 may comprise a loudspeaker 38 arranged to audibly present the textual items to the user in their selected language, in case the user cannot read or has impaired vision. The audio signal applied to the loudspeaker 38 may be stored in the repository 32 or it may be derived by the terminal 31 using a text to speech program.

The communication system and process thus provides for an efficient communication with a user in different languages.

Referring to FIG. 5 of the drawings, there is illustrated a communication system comprising an access terminal 41 which stores the contact details of recipients together with a selected language in which that recipient wishes to communicate. The system further comprising a repository 42 which is accessible by a user via the access terminal 41 and which comprises a plurality of predetermined messages in a first language together with translations of each message into a plurality of different languages. The access terminal 41 is connected via the internet 43 to a transmitter 44 which arranged to transmit SMS text messages.

Referring to FIG. 6 of the drawings, in use when a user wishes to send a predetermined message to a recipient, the user firstly uses the access terminal 41 at step 45 to select a predetermined message from the repository 42 in a default language of the system. The user firstly uses the access terminal 41 at step 46 to select one or more recipients of the message. It will be appreciated that step 46 may be carried out before step 45. The user then sends the message at step 47, whereupon the system looks up the selected language of each recipient and accesses the repository to obtain a translation of the selected message into the selected language for the or each recipient. At step 48, each translated message is then sent via the internet 43 to the transmitter 44 along with the telephone number of the respective recipient. The transmitter 44 then transmits each message to the respective recipient.

In this way SMS messages can be sent to recipients in a language which they understand and without the user having to perform any translation. The system may alternatively or additionally be arranged to transmit email or voice messages or other kinds of electronic messages using established social media or instant messaging platforms.

1. A communications system comprising an access terminal which enable a first user and a second user to communicate,
the system further comprising a repository which is accessible via said access terminal and which comprises a plurality of predetermined questions and answers, the access terminal comprising a display which is arranged to display the questions and answers and a user interface device which enables the first user to select a displayed question from the plurality of predetermined questions for the second user to answer and which enables the second user to answer the question by selecting one of the displayed plurality of answers.

2. A communications system as claimed in claim 1, which further enables the second user to select a displayed question from the plurality of predetermined questions for the first user to answer after responding to the preceding question of the first user.

3. A communications system as claimed in claim 1, in which the repository comprises a plurality of predetermined questions and answers in at least two languages.

4. A communications system as claimed in claim 3, which the system enables at least one of the users to select their language of choice prior to communicating, the system enabling the first user to select and answer questions in a first language and enabling the second user answer and select questions in a second language, so that the users can communicate in different languages.

5. (canceled)

6. (canceled)

7. (canceled)

8. (canceled)

9. A communications system as claimed in claim 1, in which the display is arranged to display a record of the questions and answers between the first user and the second user.

10. (canceled)

11. A communications system as claimed in claim 1, in which the repository of questions and answers is stored in the access terminal.

12. A communications system as claimed in claim 1, in which the repository of questions and answers is stored in a remote storage device, which is accessible by the terminal over a communications network.

13. A method of communicating using the communications system of claim 1.

14. A communication process for enabling a first and second user to communicate using a user access terminal of a communications system, the process comprising:
enabling the user access terminal to allow the first user to select a predetermined question from a plurality of predetermined questions for sending to the second user;
displaying the predetermined question from the first user to the second user on the user access terminal;
enabling the user access terminal to allow the second user to select a present answer to the question, from a plurality of present answers, for displaying on the user access terminal to the first user in response to the question.

15. A process as claimed in claim 14, which further enables the second user to select a predetermined question on the user access terminal from a plurality of predetermined questions for displaying to the first user after having responded to the preceding question from the first user.

16. A process as claimed in claim 14, in which the groups of questions and answers are categorised into separate languages, such that each group of questions and answers comprises the same questions and answers in a plurality of languages, wherein the user access terminal displays the questions and answers in a first language selected by the first user and the user access terminal displays the questions and answers in a second language to the second user.

17. (canceled)

18. (canceled)

19. (canceled)

20. A process as claimed in claim 14, in which the user access terminal displays a record of questions and answers which are communicated between the first user and the second user.

21. (canceled)

22. (canceled)

23. A communication system comprising an access terminal which enables a user to interface with a plurality of textual items stored in a repository which is accessible via said access terminal, each textual item being stored in at least two languages, the system enabling the user to select a language of choice prior to communicating such that the textual items are presented to the user from the repository in the selected language.

24. A communication system as claimed in claim 23, in which the textual items comprise a plurality of predetermined questions and answers, the questions being presented to the user from the repository in the selected language.

25. A communication system as claimed in claim 24, in which the access terminal is configured to present the user with a plurality of answers in the selected language which are selectable by the user in response to the questions.

26. A communication system as claimed in claims 23 to 25, in which the system has a default language, which is different from the selected language.

27. A communication system as claimed in claim 26, in which the system stores a record of the user's answers in the default language.

28. A communication system as claimed in claim 27, in which the system also stores a record of the user's answers in the language selected by the user.

29. (canceled)

30. A communication system as claimed in claim 23, in which the system is arranged to audibly present the textual messages to the user in their selected language.

31. A method of interaction using a communications system, the method being as claimed in claim 23.

32. (canceled)

33. (canceled)

34. (canceled)

35. (canceled)

36. (canceled)
